(19) United States
(12) Patent Application Publication
(10) Pub. No.: US 2016/0048775 A1
(43) Pub. Date: Feb. 18, 2016

(54) SYSTEM AND METHOD FOR INTERACTING WITH PATRONS

(71) Applicant: TableUp, LLC, Boston, MA (US)

(72) Inventor: Matthew F. Zibell, Boston, MA (US)

(21) Appl. No.: 14/824,799

(22) Filed: Aug. 12, 2015

Related U.S. Application Data
(60) Provisional application No. 62/037,726, filed on Aug. 15, 2014.

(51) Int. Cl. G06Q 10/02; G06Q 50/12

(52) U.S. Cl. CPC G06Q 10/02; G06Q 50/12

(57) ABSTRACT

The present invention relates to a system and method for interacting with patrons of a service provider. In particular, the present invention relates to a system and method for identifying, tracking, and assigning seating to walk-in patrons of an establishment without previously receiving information from the patron. Specifically, the system and method identifies, tracks, and assigns seating to the walk-in patrons without previously making a reservation or providing their name to be placed on a waitlist for the service provider. The walk-in patrons can enter the establishment, have the establishment be automatically alerted as to who the patron is, and be instantly enabled to assign a seating or table location for that patron in a manner that multiple devices associated with the establishment are provided with the patron information and their seating or table location.

### RELATED APPLICATION

This application claims priority to, and the benefit of, co-pending U.S. Provisional Application No. 62/037,726, filed on Aug. 15, 2014, for all subject matter common to both applications. The disclosure of said provisional application is hereby incorporated by reference in its entirety.

### FIELD OF THE INVENTION

The present invention relates to a system and method for interacting with patrons of a service provider. In particular, the present invention relates to a system and method for identifying, tracking, and assigning seating to walk-in patrons of an establishment, such as a restaurant, without placing the patrons on a reservation list or requiring they proactively or responsively provide personal information, such as a name, to a hostess directly upon arrival at the establishment.

### BACKGROUND

Generally, conventional computer-based systems exist for patrons to make dinner reservations and save their patron profile information (e.g., name, phone number, email, etc.) within a particular online system or in association with a particular restaurant or establishment. Some of these conventional computer-based systems can record the identity of a patron and then record a table at which the patron is seated by a host/hostess, so long as that patron is identified prior to being seated. Traditionally the patron can be identified prior to being seated at a table by making a reservation or by providing personally identifying information, such as a name, to the host/hostess to be manually recorded. In the case of providing the patron name to the hostess, the identifying information must be recorded manually in the system by the hostess, or other employee, to place the patron on a reservation or waitlist. In either case, the identifying information is referred to when a table is available for the waitlisted patron or when the patron eventually arrives for their reservation. Being able to identify patrons seated at a table allows the service provider to provide a personalized experience and collect additional information which can be used in subsequent visits.

However, these conventional systems experience some shortcomings. There are no known systems that record identifying information and seating information for walk-in patrons who do not have a reservation, or whose personal information is not collected by the host/hostess for use on a waitlist or to create a reservation for a later time. In other words, conventional systems require the patron provide and/or record their identifying information prior to being seated or prior to arriving at the service provider's establishment. However, typically, patrons who arrive at a service provider without a reservation and are immediately seated will not have to provide identifying information to the service provider (e.g., via the hostess). At most an establishment can obtain customer information during checkout if a patron uses a credit card to complete their transaction. As a result, these patrons will not be associated with their seating assignment or even as visitors to the service provider's establishment during their dining experience in a way that could impact the service provider's ability to influence the patron's dining experience. Accordingly, these patrons will not benefit from a personalized dining experience (e.g., utilizing historic data for the identified patrons) that is provided to patrons who make reservations or provide their identifying information to a hostess ahead of time. Similarly, once a patron has been seated, they want to enjoy their experience and not be interrupted by the hostess to obtain their identifying information. Consequently, conventional systems do not enable a service provider to identify seated patrons, that have not been previously identified, without interrupting their experience or having the patron supply information at a later date after their experience has already ended. Walk-in patrons that do not wait to be seated at a table and do not make a prior reservation represent the majority of restaurant customers. Accordingly, a need exists to provide walk-in patrons who were not added to a wait-list with the same personalized experience afforded to patrons who have provided identifying information prior to being seated.

### SUMMARY

There is a need for a system and method, implemented using a cloud-based computing infrastructure, that automatically identifies and tracks walk-in patrons, without requiring the patrons to make a reservation or respond to an inquiry from a host/hostess as to their name (e.g., for purposes of identifying the patron) for placement on a waitlist, and which additionally tracks a specific seating or table location within the establishment to which the patron is assigned. The present invention is directed toward further solutions to address this need, in addition to having other desirable characteristics.

Specifically the system and method of the present invention, provides a process by which walk-in patrons who are not added to a reservation or waitlist are automatically identified and tracked to a specific seating location (i.e., table, stool, or bar area) in an establishment. In particular, the patron (via their device) automatically communicates with a wireless location tracking technology when they enter the restaurant, such as a Bluetooth® LE indoor proximity system, for example, iBeacon™ protocol by Apple, Inc., Eddystone™ protocol by Google, Inc., or other similar device. The indoor proximity system periodically broadcasts packets of data identifying the establishment. As would be appreciated by one skilled in the art, the packets can include information for various ways of identifying the establishment (e.g., a string of a unique identifier associated with the establishment, a uniform resource locator (URL) link, etc.). The packets are discoverable by, e.g., an application or operating system on the patron's personal computing device (e.g., smartphone, tablet, portable media player, smartwatch, etc.). In response to discovering the broadcasted packets and obtaining the identifying information about the establishment from the data packets, the application or operating system initiates transmission of identifying information associated with the patron and the establishment to a server in a cloud-based computing infrastructure. The server in the cloud-based computing infrastructure then transmits the patron identifying information to an application operating on a computing device utilized by the establishment, which immediately displays the identified patron's information and enables the hostess/restaurant staff to specify a seating/table assignment for the patron and their party or for the seating/table assignment to be automatically determined by the server application.

Accordingly, the computing device of the establishment is able to receive identifying information about walk-in patrons without requiring the patrons provide their identifying information to the hostess or without having made a reservation prior to being seated. The computing device of the establishment and any additional establishment computing devices in communication therewith are able to view each table in the establishment, information about patrons that are currently or were previously seated at a particular table, as well as submit additional information about the patron and/or their visit to the establishment, for storage either in the cloud-based computing infrastructure or on the patron device. Enabling the ability to identify walk-in patrons who do not manually provide their information to a host/hostess, and who may not even wait to be seated at a table, allows establishments to provide these patrons with a more personalized experience (e.g., using historical data). Additionally, identifying walk-in patrons allows the establishment to connect to the patron's particular device to the Point of Sale (PoS) system in use at that establishment. Establishing a connection between the patron's device and the PoS system allows the patron to view their check, order additional items, and pay their bill using the patron's personal computing device. It should further be noted that while the present invention provides new functionality for walk-in patrons, it can be utilized for patrons having a previously recorded reservation or who have been placed on a waitlist, in that the identification process and seating or table assignment can still be tracked for a patron with a reservation or with a position on a waitlist. The inventive aspects of the present invention provide added functionality above and beyond such an implementation, in a novel and nonobvious implementation, as further described herein.

In accordance with one aspect of the present invention, a method for interacting with a patron at an establishment is provided. In the method, a cloud-based computing infrastructure receives an indication that a patron device associated with the patron has been automatically detected at the establishment. The method automatically updates, without requiring the patron to check in with a representative from the establishment, an establishment computing device with a notification that the patron device associated with the patron has arrived at the establishment and is awaiting a table assignment, the notification further comprising patron information data. The cloud-based computing infrastructure receives patron seating data, indicating a seating location within the establishment to which the establishment has assigned the patron.

In some implementations, the cloud-based computing infrastructure transmits a notification to the patron device indicating the seating location within the establishment to which the establishment has assigned the patron. In some implementations, the patron device interacts with a low energy wireless proximity sensor to learn a location of the patron device, the location being of the establishment, the location being inferred from a unique establishment identifier or uniform resource locator (URL) associated with the establishment, and that location being a basis for the indication that the patron device associated with the patron has been automatically detected at the establishment. In some implementations, the low energy wireless proximity sensor broadcasts data packets including the location of the establishment.

In accordance with one aspect of the present invention, a system for interacting with a patron at an establishment is provided. The system includes a patron device operated by a patron of the establishment and configured to receive proximity indication data for the establishment from a proximity sensor device associated with the establishment, the patron device operable to communicate with a cloud-based computing infrastructure. The system also includes an establishment computing device operable to communicate with the cloud-based computing infrastructure. The system further includes an application operating on the patron device operable to receive the proximity indication data from the proximity sensor device and communicate with the cloud-based computing infrastructure to share patron information data and the proximity indication data with the cloud-based computing infrastructure. The system includes an application operating on the establishment computing device associated with the application operating on the patron device, the application operating on the establishment computing device operable to exchange the patron information data and seating or table assignment information data with the cloud-based computing infrastructure. The proximity sensor device can be disposed at the establishment and detectable by the patron device, wherein upon the patron device arriving at the establishment and communicating with the proximity sensor device, the establishment computing device is notified of the existence of the patron device at the establishment, without requiring the patron to check in with a representative of the establishment, and a user of the establishment computing device is enabled to indicate the seating or table assignment to the application operating on the establishment computing device.

In some implementations, the system includes one or more establishment associated computing devices in communication with the establishment computing device and/or the cloud-based computing infrastructure. The proximity sensor device broadcasts data packets identifying the establishment. The patron information data includes identifying information about the patron. The identifying information about the patron is automatically associated with the seating or table assignment on the application operating on the establishment computing device. The identifying information about the patron is provided without indication by the patron. The patron is a walk-in patron who does not have a reservation.

In accordance with one aspect of the present invention, a method for tracking a walk-in patron without a reservation at an establishment and automatically identifying the patron is provided. In the method, a patron device carried by the patron detects data packets broadcast by a proximity sensor device associated with the establishment. An application operating on the patron device determines a unique establishment identifier from the data packets. The patron device transmits patron identifying data and the unique establishment identifier to a cloud-based computing architecture. The cloud-based computing architecture notifies an establishment computing device of an arrival by the patron at the establishment, the notifying comprising the patron identifying data. The establishment computing device assigns the patron to a seating or table assignment without requiring the patron to check in with a representative from the establishment. The establishment computing device transmits the seating or table assignment associated with the patron to the cloud-based computing architecture.

In some implementations, the seating or table assignment is transmitted to the patron device. In some implementations, the step of assigning includes selecting the seating or table assignment from a pre-existing seating or table data set. In some implementations, the establishment computing device transmits the seating or table assignment to one or more other establishment computing devices. In some implementations, the cloud-based computing architecture transmits the seating or table assignment to one or more other establishment computing devices. In some implementations, a user of the establishment computing device updates the patron identifying data with additional information. In some implementations, the additional information comprises at least one of the patron's name, address, contact information, milestones, patron food preferences, patron allergy information, patron seating preferences, and information relating to historical visits. In some implementations, the patron identifying information is provided to the establishment computing device without input from the patron. In some implementations, the patron identifying information is provided without having the patron making a reservation or being added to a waitlist.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a system for tracking walk-in patrons of an establishment;

FIG. 2 is a representative flowchart of a process of a patron entering an establishment, and the system of FIG. 1 interacting with that patron; and

FIG. 3 is a diagrammatic illustration of a high level architecture for implementing processes in accordance with aspects of the invention.

### DETAILED DESCRIPTION

An illustrative embodiment of the present invention relates to a system and method for automatically identifying when a patron is at an establishment and automatically providing information to computing devices of the establishment regarding the patron, and further enabling the establishment to indicate where the patron is seated while providing any additional establishment devices with such information, is disclosed. All of said process is accomplished without the need for the patron to make a reservation, or otherwise provide their name to, or check-in with, a host/hostess of the establishment, in response to a request from the host/hostess, for placement on a waitlist, or the like. As such, utilizing the present invention, walk-in patrons can enter the establishment, have the establishment be automatically alerted as to who the patron is, and be instantly enabled to assign a seating or table location for that patron in a manner that multiple devices associated with the establishment are provided with the patron information and their seating or table location. Accordingly, the establishment can be notified of the presence of the walk-in patron, to be associated with a seating assignment in the establishment, without requiring the patron to check in with a representative from the establishment.

The features of the present invention are a marked improvement in the technical field of customer service and management of restaurant resources including capacity in the form of available tables. Additionally, a combination of technologies is utilized (e.g., mobile computing devices, iBeacon™ protocol by Apple, Inc., Eddystone™ protocol by Google, Inc., or server computing devices, etc.) in a unique manner to carry out the technological improvements provided by the system and method of the present invention. In particular, the combination of technologies provides a new and technically improved approach to solving problems related to the customer service industry designed to improve customer satisfaction, and the throughput and management of restaurant capacity. Specifically, the present invention uses hardware devices to address a specific need to provide a personalized experience for walk-in patrons (e.g., patrons who are seated without using a reservation or signing up on a waitlist), such that the claimed invention offers significantly more than traditional conventional patron management systems. Furthermore, the ability to identify any patron at a table enables the present invention the ability to share that information with the Point of Sale (PoS) system at the establishment, which can be used to allow the patron to view the check, place food or drink order, and paying their check from their personal mobile computing device.

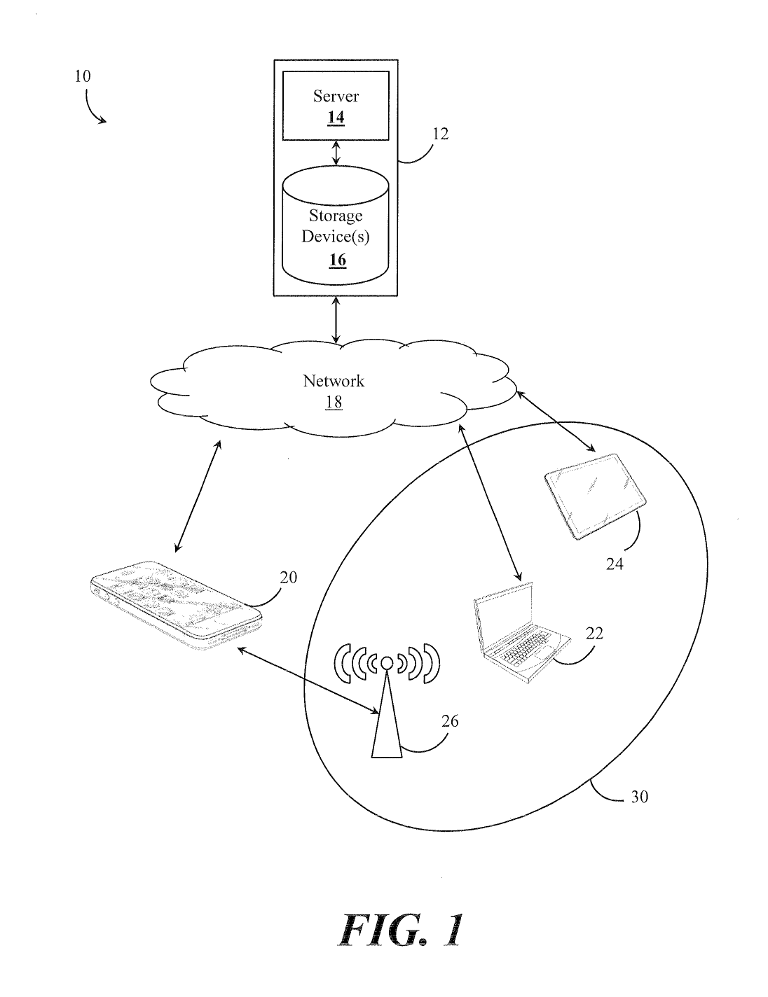

FIGS. 1 through 3, wherein like parts are designated by like reference numerals throughout, illustrate an example embodiment or embodiments of a system and method for interacting with patrons, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, in a manner still in keeping with the spirit and scope of the present invention.

FIG. 1 depicts a system 10 for interacting with patrons. Specifically, FIG. 1 depicts a system 10 for identifying, tracking, and assigning seating to walk-in patrons of an establishment and thereafter providing a customized customer experience, without placing the patrons on a reservation list or requiring they proactively or responsively provide personal information, such as a name, to a hostess directly upon arrival at the establishment. The system includes a cloud-based computing infrastructure 12 having at least one server 14 and at least one storage device 16 in inter-operable communication, forming the cloud-based computing infrastructure 12. As would be appreciated by one skilled in the art, the cloud-based computing infrastructure 12 can include or be replaced with a non-cloud based computing infrastructure. For example, the computing infrastructure 12 can include a single computing device, a collection of computing devices in a network computing system, a cloud computing infrastructure, or a combination thereof. Similarly, as would be appreciated by one of skill in the art, the at least one storage device 16 can include any combination of computing devices configured to store and organize a collection of data. For example, the at least one storage device 16 can be a local storage device to the computing infrastructure 12, a remote database facility, or a cloud computing storage environment. The at least one storage device 16 can also include a database management system utilizing a given database model configured to interact with a user for analyzing the database data.

The cloud-based computing infrastructure 12 is in communication with, and accessible through a network 18. The network 18 can be, for example, an interconnected computer and/or telecommunications network that uses standard protocols, such as TCP/IP, or the like, to link a plurality of computing devices via a broad array of electronic, wireless, and optical networking technologies, known to those of skill in the art. For example, the network 18 can be the Internet. The plurality of devices linked with the network can include a patron device 20. As would be appreciated by one skilled in the art, the patron device 20 can include a single computing device, a collection of computing devices in a network computing system, a cloud computing infrastructure, or a combination thereof. For example, the patron device 20 can be a mobile computing device such as a smart phone. In addition, the system 10 can include an establishment 30 including an establishment computing device 22, one or more establishment associated computing devices 24, and a proximity sensor 26. As would be appreciated by one skilled in the art, the establishment computing device 22 and the one or more establishment associated computing devices 24 can be computing devices as discussed with respect to the computing infrastructure 12 and/or the patron device 20 and can be operable to communicate over the network 18. The establishment computing device 22 can be a centralized computing device and the one or more establishment associated computing devices 24 can be a combination of mobile computing devices each configured to communicate with one another over the network 18.

The proximity sensor 26 is located within the establishment 30 and operates in association with the establishment 30. The establishment 30 can be a brick and mortar service provider, which typically provides seating arrangements for consumers. For example, a restaurant, movie theatre, auditorium, bar, etc. The proximity sensor 26 can make use of wireless technology, including but not limited to Bluetooth® Low Energy, and is likely positioned at or near an entrance to the establishment 30, or proximal a podium or desk where a host/hostess operates. The proximity sensor 26 wirelessly periodically transmits data including a universally unique identifier specific to that establishment within a nearby range as would be understood by those of skill in the art familiar with Bluetooth® Low Energy devices and ranges. For example, every 3 seconds the proximity sensor 26 wirelessly transmits data packets the unique identifier for the establishment. As would be appreciated by one skilled in the art, the proximity sensor 26 can communicate with and transmit data to the patron device 20 via a one way or two way communication interface. The wirelessly transmitted data can be received by any compatible computing device, which can support an application, an operating system, or the like. In accordance with an example embodiment of the present invention, the patron device 20 is operating an application that is compatible with such proximity sensor 26. As would be appreciated by one skilled in the art, the patron device 20 can communicate with the proximity sensor 26 without requiring an application specifically designed for communication with the proximity sensor 26. For example, the proximity sensor can transmit a URL which can be detected by the patron device 20 operating system and subsequently can be opened on a web browser application installed on the patron device 20. In certain example embodiments herein, the process described makes use of an application to interact with the data. It should be noted that the present invention is not intended to be limited only to the example embodiments making use of applications (whether native, proprietary, or otherwise), and that the present invention is intended to include any such tool operating on a patron device 20 that has the ability to interact with the incoming data and the outgoing date to effect the functionalities and features described herein, as would be appreciated by those of skill in the art. Accordingly, a native proprietary application can respond to, e.g., a data packet originating from an indoor proximity system using the iBeacon™ protocol by Apple, Inc., the Eddystone™ protocol by Google, Inc., or other similar device, and can make use of the data in the manner described herein using the example of the application.

The patron device 20 application receives the universally unique identifier or URL from the proximity sensor 26. This can come through as, e.g., an alert, a notification, a text message, a chat message, or any form that can be received and displayed by the patron device 20 in a manner that enables the patron user to observe the information and take the desired action. The patron device 20 can either receive information about the establishment directly from the universally unique identifier, or the patron device 20 can use the unique identifier to look up information about the establishment (e.g., over the Internet). For example, the patron device 20 can communicate with the cloud-based computing infrastructure 12 to identify the establishment (e.g., using a lookup table), over the cellular or Wi-Fi wireless capabilities of the patron device 20 (e.g., the network 18), which provides back to the patron device 20 an indication of the establishment at physical location of the patron device 20. The physical location can include an identification of the establishment 30, i.e., the particular restaurant that the patron device 20 is located. In accordance with an example embodiment of the present invention, the patron device 20 does not have to perform the identification of the establishment itself. For example, the patron device 20 can send the unique identification information received from the proximity sensor 26 and the unique information for the patron to the cloud-based computing infrastructure 12 (e.g., server 14) for processing. In this example implementation, the patron device 20 never interprets the unique identification information to identify the establishment, instead the unique information is used by the cloud-based computing infrastructure 12 to identify the establishment and send the patron information to establishment computing device(s) 22, 24.

When the application operating on the patron device 20 receives/discovers the data identifying the establishment, the application operating on the patron device 20 transmits identifying information about the patron and the identification of the establishment to the server 14. As would be appreciated by one skilled in the art, the information about the patron can be stored locally on the patron device 20, associated with the application, or it can be stored remotely at another data storage location accessible by the patron device 20 or the server 14 (e.g., a cloud server). In response to receiving the information about the patron and the identification of the establishment, the server 14 transmits the patron and establishment information data to the establishment computing device 22, via the network 18 (or at a minimum transmits the patron information to the establishment, using the establishment information to identify where to transmit the patron information). The transmission of patron and establishment information data to the establishment computing device 22 can occur through either a push notification or alert, a periodic pull from the establishment computing device 22, or other means known in the art, as would be appreciated by those of skill in the art. The above processes can be performed instantly from the perspective of the user. The patron and establishment information data provides to the establishment computing device 22 with any information the patron operating the patron device 20 wishes to convey. For example, the patron and establishment information data can include the patron's name, address, contact information, milestones, photograph, and other personal identifying information, patron food preferences, patron allergy information or other medical condition information, patron seating preferences, information relating to historical visits by the patron device 20 (and therefore the patron) to the establishment 30, and any other such information desired to be conveyed.

It should be noted that the patron device 20 is the device executing the relevant application on behalf of the patron. As would be appreciated by those of skill in the art, the application can be an application specifically tailored to carry out the functions of the present invention or the application can be a non-specific application configured to receive and/or utilize the information received from the proximity sensor(s) 26. For example, the patron device 20 can receive a URL from the proximity sensor, open the URL using the default web browser application on the device. Additionally, the application executing on the patron device 20 can be executed on multiple different devices owned or operated by the patron, historically and into the future, where the relevant patron data can be attached to a login and account accessible by the application, such that the patron can access the application and the relevant data on numerous computing devices. For example, a first patron can login to a second patron's device and the first patron's information will be conveyed to the establishment computing device 22.

It should further be noted that as utilized herein, processes that involved transmitting information and data from one device to another can be implemented utilizing a number of technologies. For example, transmitting information to the patron device 20, the server 14, to the establishment computing device 22, or the establishment associated computing devices 24, as referred to in various steps discussed herein, can be implemented in accordance with the present invention utilizing such technologies as those for messaging, texting, chat, email, instant messaging, notifications, alerts, and the like, including any such technologies useful for communication between two or more devices over a wireless network, including the Internet, cellular, or otherwise, as would be appreciated by those of skill in the art and readily implemented in accordance with the teachings of the present application.

When the patron and establishment information data is received by the establishment computing device 22, information is displayed on the establishment computing device 22 to at least show the presence of the patron and the patron device 20 in the establishment 30 (i.e., a display shows when a walk-in patron, by name, has arrived and wishes to be seated), and may initially show some basic patron information, such as the patron's name and seating preference. The host/hostess or any other employee operator of the establishment computing device 22 then indicates and records a seating and/or table assignment on the establishment computing device 22. This seating and/or table assignment can be entered prior to the patron being seated, as the patron is seated, or subsequent to the patron being seated. For example, the hostess can select the table that the patron has been seated from an existing data set of tables on the establishment computing device 22 or the one or more establishment associated computing devices 24. As would be appreciated by one skilled in the art, the seating information can be stored locally on the establishment computing device 22 or the one or more establishment associated computing devices 24, or the seating information can be stored remotely on the storage device(s) 16 and communicated to the establishment computing device 22 or the one or more establishment associated computing devices 24. The seating and/or table assignment is recorded and stored in an application on the establishment computing device 22, and is additionally transmitted and stored by the server 14 in the cloud-based computing infrastructure 12. Those of skill in the art will appreciate that it may be possible for the patron information and the seating or table assignment information to be forwarded only to devices within the establishment 30, though while such implementation can execute some of the functionally of the present invention, not all functionality is executable, including some of the forwarding of patron information to other establishments at other times. For example, the establishment can forward the patron information to other establishments of the same chain or corporate structure to be sorted on their local establishment computing devices (e.g., establishment computing devices 22).

One or more establishment associated computing devices 24 that are used by establishment employees are also updated with the seating or table assignment of the patron (and patron device 20) and also have access to the patron information. For example, the server 14 can transmit the seating and/or table assignment to the one or more establishment associated computing devices 24. As such, the establishment computing device 22 and the one or more establishment associated computing devices 24 all have access to, and can display to users, for each seat and/or table in the establishment, information about current and previous patrons at that table, Likewise, the patron device 20 can also be updated with their assigned seating or table location as well. For example, the server 14 can transmit the seating and/or table assignment to the patron device 20 for storage in the patron's historical information. Those of skill in the art will appreciate that the establishment computing device 22 and the one or more establishment associated computing devices can all execute the application providing access to the patron information and the seating or table assignment in like manner, such that the establishment computing device 22 and the one or more establishment associated computing devices 24 can be interchangeable. The system can be configured such that any updates regarding patrons (and patron devices 20) arriving at the establishment are sent to both establishment computing device 22 and the one or more establishment associated computing devices 24 simultaneously, such that users of such devices can assign the seating or table from any of these establishment computing devices 22, 24, and implement the steps of the present invention as discussed herein from any of the establishment computing devices 22, 24. The system can also be configured such that initial indications of patron arrival at the establishment 30 only go to the establishment computing device 22, and then once the table or seating assignment is entered the patron information and seating or table assignment is distributed to the one or more establishment associated computing devices 24.

Applications operating on the establishment computing device 22 and the one or more establishment associated computing devices 24 further enable additional data or information to be entered relating to the patron as associated with the patron device 20, such as comments regarding service, patron preferences, experiences of the patron, and the like.) Any such information can be entered and associated with the patron and the patron device 20, and stored by the server 14 of the cloud-based computing infrastructure 12, such that it may be accessed in the future by any establishment frequented by the patron and patron device 20.

The patron device 20 can take a number of different forms, including but not limited to a mobile device, smartphone, tablet computer, notebook computer, smart watch, or other computing device capable of operating an application and interacting with wireless networks, including the Internet, and other wireless devices, including the proximity sensor 26, as would be appreciated by those of skill in the art. Likewise, the establishment computing device 22 and the establishment associated computing devices 24 can also take the form of a mobile device, smartphone, tablet computer, notebook computer, desktop computer, smart watch, or other computing device capable of operating an application or website on a web browser application and interacting with wireless networks, including the Internet, and other wireless devices, as would be well understood by those of skill in the art.

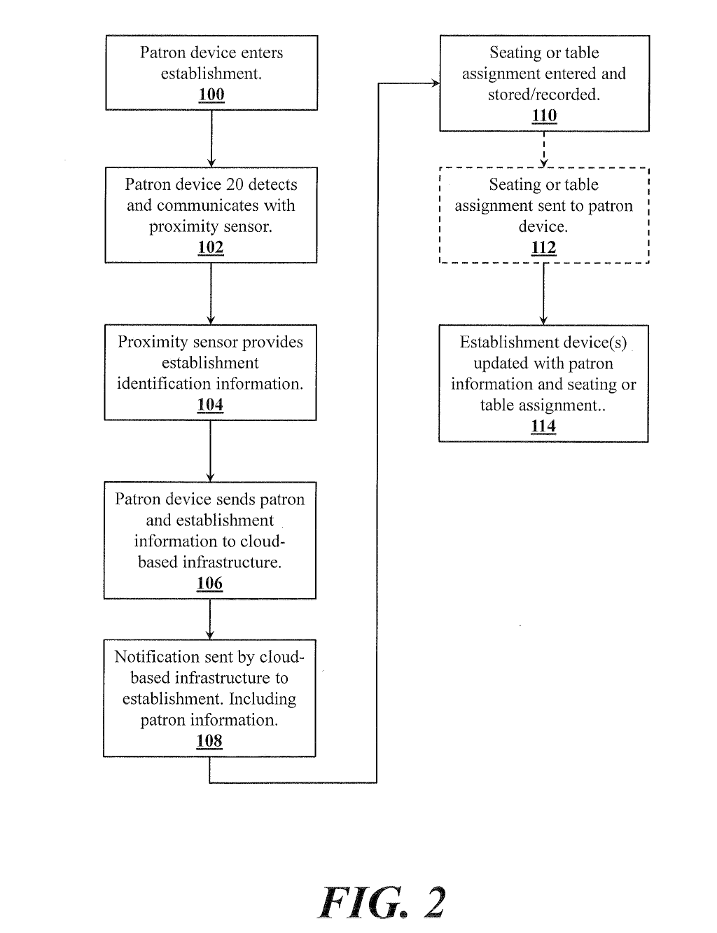

In operation, as shown in FIG. 2, the patron with their patron device 20 enters the establishment 30 (step 100). The patron device 20, operating the application, detects and communicates with the proximity sensor 26 (step 102). In accordance with an example embodiment of the present invention, the proximity sensor 26 can broadcast data packets including a unique identifier and/or a website URL and the patron device 20 can detect the data packets and save the unique identifier from the data packets. The data packets broadcast by the proximity sensor 26 conveys the universally unique identifier specific to that establishment (step 104), which itself communicates establishment information, or alternatively enables the patron device 20 to obtain establishment information via, for example, the Internet. For example, the data packets provide the information necessary to obtain the unique identifier for the establishment, as discussed with respect to FIG. 1. The application operating on the patron device 20 transmits information about the patron and the identification of the establishment to the cloud-based computing infrastructure (step 106). As would be appreciated by one skilled in the art, steps 100-106 can be performed automatically by the application on the patron device 20 transparently to the patron.

Continuing with FIG. 2, the cloud-based computing infrastructure 12 transmits a notification to the establishment computing device 22 (step 108), the notification including patron information and the identification of the establishment. A user of the establishment computing device 22 (or alternatively any of the one or more establishment associated computing devices 24) enters a specific seating and/or table assignment for the patron and the application operation on the establishment computing device 22 transmits the seating and/or table assignment information for the patron to the cloud-based computing infrastructure (step 110). If desired, the cloud-based computing infrastructure can transmit the seating or table assignment information to the patron device (step 112). The establishment computing device 22 and any of the one or more establishment associated computing devices 24 are updated by the cloud-based computing infrastructure with the patron information and the seating and/or table assignment (step 114).

The process of transmitting information about an identified patron from the application on the patron device 20 and the establishment 30 (i.e., the patron and establishment information data) to the server 14 and subsequently to an application on the establishment computing device 22 for purposes of assigning and recording seating or table assignments differs from conventional forms of location based identification using GPS and iBeacon™ protocol devices, at least in part because simply knowing a restaurant patron is in the building or their exact current location in the establishment is not as useful as knowing at which specific table the patron is seated, who the patron is, and having further capabilities in such information as historically how the patron has interacted at the establishment, including patron preferences and other information. Attempting to determine at which table the patron is seated using proximity based tools and other known conventions other than the present system and method is generally unreliable since establishment patrons may walk around the establishment, e.g., to visit the restroom, bar, chat with other tables, and the like. Whereas the proactive selection of the seating or table assignment by an establishment employee such as the host/hostess provides much more reliable information. In accordance with an example embodiment of the present invention, proximity devices 26 (e.g., Beacons) can be placed under each table to help eliminate confusions if the tables are moved in the establishment. Additionally, in the even that a proximity device 26 fails, (e.g., battery dies), patrons will automatically be assumed to be seated at a nearby table.

From the perspective of the establishment 30, walk-in patrons who do not wait for their table represent the majority of customers at, e.g., a restaurant form of establishment 30. With the present inventive system and method, restaurants can now view and capture information for non-waitlist walk-in patrons, allowing them to offer a more personalized patron experience and a higher level of hospitality to these customers. From the patron's perspective, they can now receive a more personalized dining experience at restaurants they visit repeatedly. In addition, if the patron chooses to release such information, the patron may release information that creates a more personalized dining experience even when visiting an establishment 30 for the first time, because such information (such as food preferences, allergy information, seating preferences, and the like) can translate to a plurality of different establishments, and be acted upon accordingly by the employees of that establishment 30.

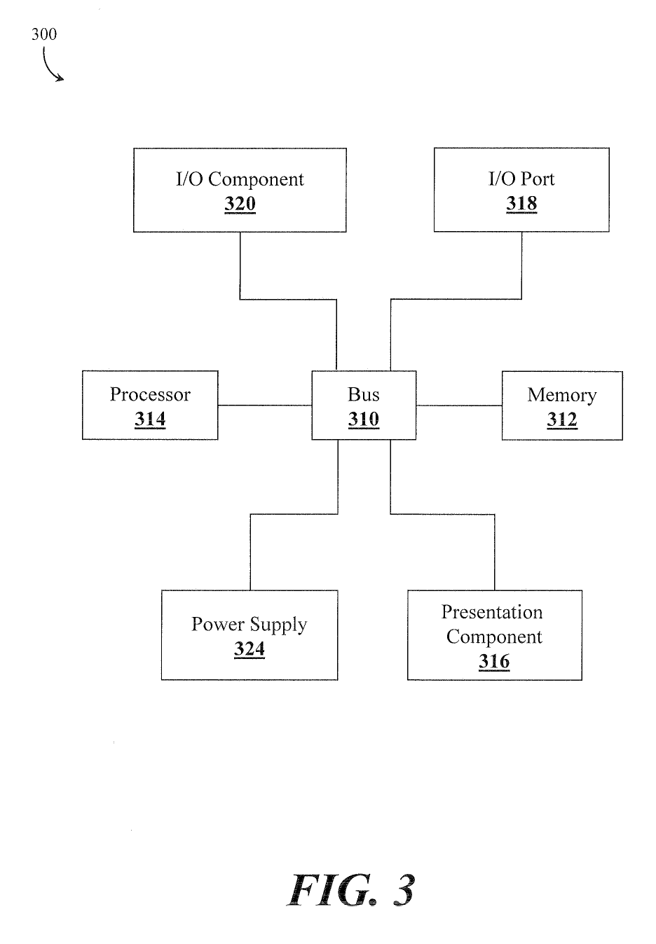

Any suitable computing device can be used to implement the computing devices 20, 22, 24 and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 300 is depicted in FIG. 3. The computing device 300 is merely an illustrative example of a suitable computing environment and in no way limits the scope of the present invention. A “computing device,” as represented by FIG. 3, can include a “workstation,” a “server,” a “laptop,” a “desktop,” a “hand-held device,” a “mobile device,” a “tablet computer,” or other computing devices, as would be understood by those of skill in the art. Given that the computing device 300 is depicted for illustrative purposes, embodiments of the present invention may utilize any number of computing devices 300 in any number of different ways to implement a single embodiment of the present invention. Accordingly, embodiments of the present invention are not limited to a single computing device 300, as would be appreciated by one with skill in the art, nor are they limited to a single type of implementation or configuration of the example computing device 300.

The computing device 300 can include a bus 310 that can be coupled to one or more of the following illustrative components, directly or indirectly: a memory 312, one or more processors 314, one or more presentation components 316, input/output ports 318, input/output components 320, and a power supply 324. One of skill in the art will appreciate that the bus 310 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 3 is merely illustrative of an exemplary computing device that can be used to implement one or more embodiments of the present invention, and in no way limits the invention.

The computing device 300 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 300.

The memory 312 can include computer-storage media in the form of volatile and/or nonvolatile memory. The memory 312 may be removable, non-removable, or any combination thereof. Exemplary hardware devices are devices such as hard drives, solid-state memory, optical-disc drives, and the like. The computing device 300 can include one or more processors that read data from components such as the memory 312, the various I/O components 316, etc. Presentation component(s) 316 present data indications to a user or other device. Exemplary presentation components include a display device, speaker, printing component, vibrating component, etc.

The I/O ports 318 can enable the computing device 300 to be logically coupled to other devices, such as I/O components 320. Some of the I/O components 320 can be built into the computing device 300. Examples of such I/O components 320 include a microphone, joystick, recording device, game pad, satellite dish, scanner, printer, wireless device, networking device, and the like.

Numerous modifications and alternative embodiments of the present invention will be apparent to those skilled in the art in view of the foregoing description. For example, the present system and method can be implemented with additional functionality, such as managing a payment process for services rendered to the patron while at the establishment, managing a rewards or loyalty program between the patron and the establishment, capturing patron order data via a connection with the POS system, and/or other such services that may be required for interaction with the establishment, and which are known by those of skill in the art.

Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method for interacting with a patron at an establishment, the method comprising:
a cloud-based computing infrastructure receiving an indication that a patron device associated with the patron has been automatically detected at the establishment;
without requiring the patron to check in with a representative from the establishment, automatically updating an establishment computing device with a notification that the patron device associated with the patron has arrived at the establishment and is awaiting a table assignment, the notification further comprising patron information data;
the cloud-based computing infrastructure receiving patron seating data, indicating a seating location within the establishment to which the establishment has assigned the patron.

2. The method of claim 1, further comprising the cloud-based computing infrastructure transmitting a notification to the patron device indicating the seating location within the establishment to which the establishment has assigned the patron.

3. The method of claim 1, further comprising the patron device interacting with a low energy wireless proximity sensor to learn a location of the patron device, the location being of the establishment, and that location being a basis for the indication that the patron device associated with the patron has been automatically detected at the establishment.

4. The method of claim 3, wherein the low energy wireless proximity sensor broadcasts data packets including a unique identifier or uniform resource locator (URL).

5. A system for interacting with a patron at an establishment, the system comprising:
a patron device operated by a patron of the establishment and configured to receive proximity indication data for the establishment from a proximity sensor device associated with the establishment, the patron device operable to communicate with a cloud-based computing infrastructure;
an establishment computing device operable to communicate with the cloud-based computing infrastructure;
the patron device operable to receive the proximity indication data from the proximity sensor device and communicate with the cloud-based computing infrastructure to share patron information data and the proximity indication data with the cloud-based computing infrastructure;
an application operating on the establishment computing device associated with the application operating on the patron device, the application operating on the establishment computing device operable to exchange the patron information data and seating or table assignment information data with the cloud-based computing infrastructure; and
the proximity sensor device disposed at the establishment and detectable by the patron device;
wherein upon the patron device arriving at the establishment and communicating with the proximity sensor device, the establishment computing device is notified of the existence of the patron device at the establishment without requiring the patron to check in with a representative of the establishment, and a user of the establishment computing device is enabled to indicate the seating or table assignment to the application operating on the establishment computing device.

6. The system of claim 5, further comprising one or more establishment associated computing devices in communication with the establishment computing device and/or the cloud-based computing infrastructure.

7. The system of claim 5, wherein the proximity sensor device broadcasts data packets or a website uniform resource locator (URL).

8. The system of claim 5, wherein the patron information data includes identifying information about the patron.

9. The system of claim 8, wherein the identifying information about the patron is automatically associated with the seating or table assignment on the application operating on the establishment computing device.

10. The system of claim 8, wherein the identifying information about the patron is provided without indication by the patron.

11. The system of claim 8, wherein the patron is a walk-in patron who does not have a reservation.

12. A method for tracking a walk-in patron without a reservation at an establishment and automatically identifying the patron, the method comprising:
detecting, by a patron device carried by the patron, data packets broadcast by a proximity sensor device associated with the establishment;
determining, by the patron device, a unique establishment identifier from the data packets;
transmitting, by the patron device, patron identifying data and the unique establishment identifier to a cloud-based computing architecture;
notifying, by the cloud-based computing architecture, an establishment computing device of an arrival by the patron at the establishment, the notifying comprising the patron identifying data;
assigning, by the establishment computing device, the patron to a seating or table assignment without requiring the patron to check in with a representative from the establishment; and
transmitting, by the establishment computing device, the seating or table assignment associated with the patron to the cloud-based computing architecture.

13. The method of claim 12, wherein the seating or table assignment is transmitted to the patron device.

14. The method of claim 12, wherein the step of assigning comprises selecting the seating or table assignment from a pre-existing seating or table data set.

15. The method of claim 12, wherein the establishment computing device transmits the seating or table assignment to one or more other establishment computing devices.

16. The method of claim 12, wherein the cloud-based computing architecture transmits the seating or table assignment to one or more other establishment computing devices.

17. The method of claim 12, wherein a user of the establishment computing device updates the patron identifying data with additional information.

18. The method of claim 17, wherein the additional information comprises at least one of the patron's name, address, contact information, milestones, patron food preferences, patron allergy information, patron seating preferences, and information relating to historical visits.

19. The method of claim 12, wherein the patron identifying information is provided to the establishment computing device without input from the patron.

20. The method of claim 12, wherein the patron identifying information is provided without having the patron making a reservation or being added to a waitlist.
